(19) United States
(12) Patent Application Publication
(10) Pub. No.: US 2020/0320590 A1
(43) Pub. Date: Oct. 8, 2020

(54) CUSTOMER MANAGEMENT SYSTEM

(71) Applicant: Austin Childs, Orem, UT (US)

(72) Inventor: Austin Childs, Orem, UT (US)

(21) Appl. No.: 16/740,743

(22) Filed: Jan. 13, 2020

Related U.S. Application Data
(60) Provisional application No. 62/791,433, filed on Jan. 11, 2019.

(51) Int. Cl. G06Q 30/02; G06Q 10/06; H04M 3/51

(52) U.S. Cl. CPC G06Q 30/0281; H04M 3/5175; G06Q 10/06398; G06Q 10/06393

(57) ABSTRACT

Disclosed herein is a digital processing system for determining improved scenarios for customers and agents based upon customer historical data and a quantifiable issue. The system may include a processor, a display device, and a computer-readable storage medium. The processor may identify a rating for a customer, display the rating on the display device, determine that the rating meets a predetermined threshold and propose updated terms of the relationship scenario based on the rating. The updates may be stored in the computer-readable storage medium.

### PRIORITY CLAIM

This application claims priority to U.S. Patent Provisional Application No. 62/791,433, filed on Jan. 11, 2019 which is herein incorporated by reference in its entirety.

### BACKGROUND

### 1. Technical Field

This disclosure relates generally to digital processing systems for customer contact centers.

### 2. Description of the Related Art

A contact center, such as a call or online chat center, is a centralized system used for receiving or transmitting a large volume of communications by phone or real-time messaging. Modern contact centers generally incorporate computer-based systems for handling communications and managing customer information. Contact centers are manned by trained agents to respond to customer inquiries. In addition, contact centers may haver supervisors to manage large groups of agents.

Customers may initiate inbound communications with a contact center using a wide range of customer devices, including, smart phones and computers. Agents and supervisors may use computing devices to respond to customers' inbound communications. The agents' and supervisors' computing devices may include a headset that allows the voice communications. In addition, the agents' and supervisors' computing devices may include a digital display for displaying customer information. Inbound communications to a contact center may be managed by a centralized contact center management system.

A contact center's management system typically routes each inbound contact from a customer to an agent who is available and qualified to service the contact. Coupled to these systems are queues for holding incoming contacts to await service by an available agent. Contact centers typically organize their agents into “queue groups;” where each queue group consists of agents with similar qualifications and training. A highly qualified agent, for example, might be a member of two or more queue groups. But, in most cases, an agent is only a member of a single queue group due to high turnover, cost of training, and system limitations. For example, an agent trained in technical support is most likely not trained in sales and vice versa.

In large contact centers, queue groups may be organized into various customer interfacing departments, including sales, billing, technical support, and general customer support. Computer-based contact center management systems assess and categorize each incoming contact. For example, inbound contacts may be presented with an automated selection menu that allows customers to select the reason for the contact. Based on the categorization, the computer-based contact center management systems match the customer to an appropriate queue group. Once an agent is available, the systems establish a two-way communication session between the customer and the agent.

Often during a session with a customer, agents are forced to transfer the customer to another department, or queue group, within an organization. For example, an agent trained in technical support may have to transfer a customer to an agent trained in sales in order to resolve an aspect of the customer's issue. Then, the sales agent may be required to transfer the customer to billing, and so on, until the customer's issues are fully resolved by the organization. The foregoing example, however, most often results in a high level of customer dissatisfaction due to the multiple transfers within the organization to resolve the customer's issue. If the customer's level of dissatisfaction is high, the customer may even terminate the relationship with the organization.

One previous solution to the aforementioned problem was to cross-train agents across multiple aspects of an organization. This solution has several drawbacks. First, cross-training agents is time consuming and expensive especially in light of the high turnover in most contact centers. Second, the functionality of previously available computer-based contact center management systems limited the abilities of the agents to handle several unrelated customer issues. Further, even when an agent attempted to handle multiple issues, the agent often made decisions that resolved the customer's issue but that were unprofitable to the organization due to the lack of information available to the agent. While this was a win for the customer, it was a loss to the organization's desire to maintain profitability.

Accordingly, it is one object of this disclosure to provide an improved computer-based contact center management system that reduces and, in some instances, eliminates the above-described drawbacks of the prior art. Another object of this disclosure is to reduce the level of training of contact center agents while still allowing them to handle multiple-unrelated customer issues during a single session. Another object of this disclosure to is to reduce the need to transfer customers between different queue groups of a contact center to resolve customer issues. Another object of this disclosure is to improve profitability on each customer while resolving customer issues. Another object of this disclosure is to provide customer profitability information to contact center agents in order to allow them to make informed modifications to customer accounts.

### SUMMARY

Disclosed herein is a digital processing system for a customer contact center. The digital processing system may include an agent interface module that provides customer information in a dashboard configuration on the display of agents working in the customer contact center. The digital processing system may further include a scenario calculation module operable to process customer account information to determine one or more improved scenarios for both the customer and an organization. That is, the scenario calculation module may employ various computer-implemented algorithms to optimize the customers' interactions with the customer contact center by providing improved scenarios to agents in order to resolve customer issues while increasing or maintaining customer profitability in the long term. The scenario calculation module may automatically adjust aspects of the customers account in response to real-time input entered by agents during contacts with customers in order to maintain or increase customer profitability.

Further disclosed herein is a processor-implemented method of determining improved scenarios in-real time that resolve customer issues while maintaining a pre-determined profitability margin for the customer. The method further includes providing a virtual dashboard on a computer display that allows an agent to select between the improved scenarios based upon a customer's profitability rating. The method further includes providing improved scenarios in-real time based upon agent input and the profitability of a customer to an organization.

Further disclosed herein is a method for transferring data for improved scenarios across a multicomputer data network. The method further includes analyzing, by the one or more processors within the multicomputer data network, customer account and historical information to determine a customer profitability rating. The method further includes determining, by the one or more processors within the multicomputer data network, improved scenarios for the customer that increase or maintain the profitability of the customer to an organization. The method further includes prohibiting an agent from modifying a customer's account in a manner that results in a loss of profitability of the customer to an organization. Finally, the method includes displaying, by the one or more processors within the multicomputer data network, the improved scenarios to an agent in a virtual dashboard and allowing the agent to select one of the improved scenarios during a real-time communication with the customer.

### BRIEF DESCRIPTION OF THE DRAWINGS

The accompanying drawings illustrate various embodiments of the multicomputer network system that provides a spreadsheet application.

FIG. 1 illustrates an exemplary contact center that allows agents of an organization and customers to communicate in real-time over a communications network;

FIG. 2 illustrates a contact center management server connected to an agent device and a supervisor device over a local area network;

FIG. 3 illustrates a virtual dashboard on a computer display and populated with customer information generated by the agent device shown in FIG. 2;

FIG. 4 illustrates a virtual dashboard on a computer display with a popup window populated with improved scenarios generated by the contact center management server shown in FIG. 2;

FIG. 5 illustrates a virtual dashboard on a computer display populated with agent information generated by the supervisor device shown in FIG. 2;

FIG. 6 illustrates a virtual dashboard on a computer display populated with agent information generated by the supervisor device shown in FIG. 2; and

FIG. 7 depicts a process of generating improved scenarios for customers based upon customer historical data and a current customer issue.

### DETAILED DESCRIPTION OF PREFERRED EMBODIMENTS

In the following description, for purposes of explanation and not limitation, specific techniques and embodiments are set forth, such as particular techniques and configurations, in order to provide a thorough understanding of the device disclosed herein. While the techniques and embodiments will primarily be described in context with the accompanying drawings, those skilled in the art will further appreciate that the techniques and embodiments may also be practiced in other similar devices.

Reference will now be made in detail to the exemplary embodiments, examples of which are illustrated in the accompanying drawings. Wherever possible, the same reference numbers are used throughout the drawings to refer to the same or like parts. It is further noted that elements disclosed with respect to particular embodiments are not restricted to only those embodiments in which they are described. For example, an element described in reference to one embodiment or figure, may be alternatively included in another embodiment or figure regardless of whether or not those elements are shown or described in another embodiment or figure. In other words, elements in the figures may be interchangeable between various embodiments disclosed herein, whether shown or not.

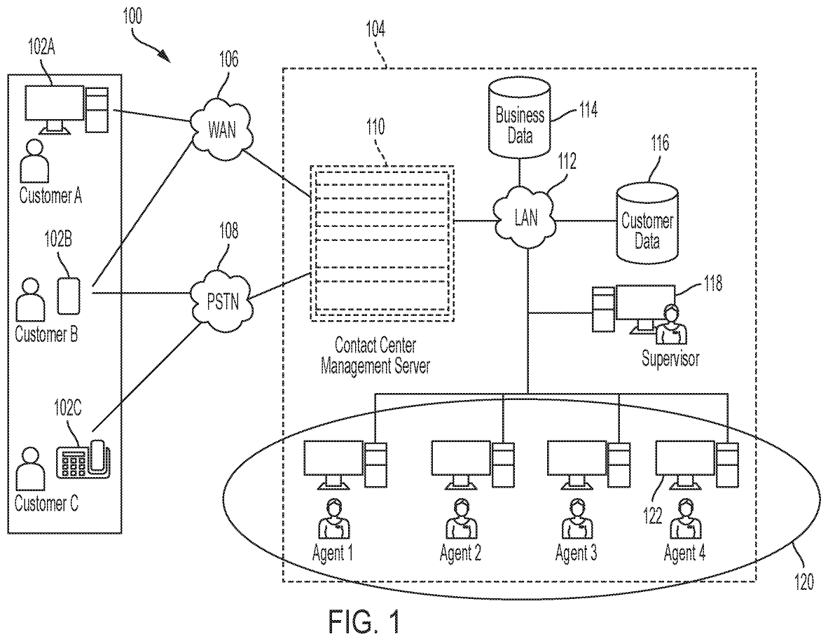

FIG. 1 illustrates an exemplary customer contact environment 100 that provides two-way communication between customers and agents over a network. The environment 100 includes a plurality of customer devices 102A-102C, generally referred to as customer devices 102, connected to a customer contact center 104. The customer devices 102 may connect over a wide area network (WAN) 106 or a public switched telephone network (PSTN) 108 to the contact center 104 in a manner known to those of ordinary skill in the art.

The contact center 104 may include a contact center management server 110. In its basic form, the contact center management server 110 is a computing device that may include, for example and without limitation, a processor, microcomputer, minicomputer, mainframe, and laptop. The contact center management server 110 may further include a memory for storing certain software applications used in obtaining, processing, and communicating information. It can be appreciated that such memory may be internal or external with respect to operation of the disclosed embodiments. The memory may also include any means for storing software, including a hard disk, an optical disk, floppy disk, ROM (read only memory), RAM (random access memory), PROM (programmable ROM), EEPROM (electrically erasable PROM) and/or other computer-readable memory media.

Further, any of the computer servers described herein, including the contact center management server 110, may include a “server farm” or other grouping of networked servers (e.g., a group of server blades) that are located and configured for cooperative functions. It can be appreciated that a server farm may serve to distribute workload between/among individual devices of the server farm and may expedite computing processes by harnessing the collective and cooperative power of multiple servers. Such server farms may employ load-balancing software that accomplishes tasks such as, for example, tracking demand for processing power from different machines, prioritizing and scheduling tasks based on network demand, and/or providing backup contingency in the event of component failure or reduction in operability.

Customers may employ the customer devices 102 to initiate a two-way communication session with the contact center 104 through various means. For example, two-way communication sessions may be performed using an online chat server, text messing, voice-over-internet protocol (VOIP), data packets, wired transmissions, wireless transmissions and traditional switched networks. Sessions may be initiated using a web browser program running on a customer device 102. Sessions may also be initiated using a dedicated software application running on a customer device 102. Sessions may also be initiated by a customer calling a telephone number associated with the contact center 104. Alternatively, sessions may be initiated by the contact center 104.

The contact center management server 110 is connected to various computing devices of the contact center 104 over a local area network (LAN) 112. Connected to the LAN 112 is a business database 114 having business data stored therein. The business data may include information regarding products and/or services offered to the customers. The business data may further include pricing information and service plan information.

Further connected to the LAN 112 is a customer database 116 having customer data stored therein. The customer data may include customer information, including customer names, account information, payment history, previous interaction information and products and/or services attributed to the customers. The databases 114 and 116 may each include a database server which houses a database application that provides database services to other computer programs and to computers connected to the LAN 112. The information stored in the databases may be stored in a high-capacity data storage device, such as a hard disk or an array of hard disks.

A supervisor device 118 and a plurality of agent devices 122 are also connected to the LAN 112. The supervisor device 118 may be manned by a human supervisor charged with supervising agents that man the agent devices 122. The devices 118 and 122 may include one or more of a processor, a desktop computer, a microcomputer, a minicomputer, a server, a mainframe, a terminal, and a laptop. The devices 118 and 122 may further include memory for storing certain software applications used in obtaining, processing, and communicating information. It can be appreciated that such memory may be internal or external with respect to operation of the disclosed embodiments. The memory may also include any means for storing software, including a hard disk, an optical disk, floppy disk, ROM (read only memory), RAM (random access memory), PROM (programmable ROM), EEPROM (electrically erasable PROM) and/or other computer-readable memory media. The devices 118 and 122 may further include a computer display.

As mentioned, the agent devices 122 may be manned by a pool of human agents 120. The pool of human agents 120 may participate in two-way communication with the customers through the contact center 104. In operation, the agents respond to the customers in kind. For example, if a customer initiates a session via online chat, the agents are able to respond to the customer using online chat.

The operation of the contact center 104 will now be generally described. A customer with an issue may initiate an inbound communication with the contact center 104 using one of the customer devices 102. The customer, for example, may initiate a telephone call with customer device 1028 to the contact center 104. The contact center management server 110 may receive the inbound communication over a network, such as the WAN 106 or PSTN 108. The contact center management server 110 may then route the inbound communication to one of the agents in the pool of agents 120. That is, the contact center management server 110 establishes a communication link between the customer device 102 and one of the agent devices 122. Again, this link may be a voice communication or online communication. If no agents are available, the inbound communication may be placed in a queue.

When the communication link is established, the agent device 122 may automatically request and receive information regarding the customer from the customer database 116. Alternatively, the agent may perform a database search to retrieve the pertinent customer data. This information may include the name and address of the customer as well as the details of the customer's relationship with the organization, e.g., such as the products and/or services previously purchased or subscribed to by the customer. In addition, the agent device 122 may be provided with information from the business database 114. The customer's information and the business data may be displayed on a display of the agent device 122 to allow the agent to review, manage, update, and modify the information.

Using the information provided from the customer database 116 and the business database 114, the agent may be able to easily resolve the customer's issue. If needed, the agent may include a supervisor that is manning the supervisor device 118 to assist in resolving the customer's concern. That is, the agent may initiate an electronic conference request to the supervisor through the agent device 122. The electronic conference request may be received at the supervisor device 118. The agent device 122 and the supervisor device 118 may screen share so that both the agent and the supervisor are able to see the same information. In addition, the supervisor may be able to participate in the session with the customer. With the above description of the general operation of the contact center 104 in mind, further details of the present disclosure will now be described.

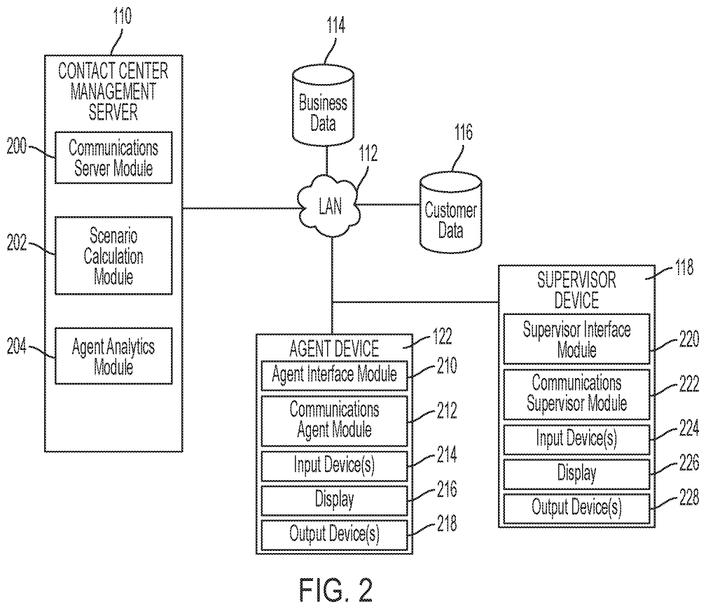

Referring now to FIG. 2, there is shown aspects of the contact center 104 in additional detail. With reference to FIG. 2, some of the features of the present disclosure are described as “modules.” It will be appreciated that a module is a hardware device that may include a processor and a memory. Stored in the memory are computer-readable instructions, that, when executed, cause the module to perform the features and functionality described herein. Accordingly, as used herein, a module comprises hardware components that may include a combination of Central Processing Units (“CPUs”), processors, buses, volatile and non-volatile memory devices, storage units, non-transitory computer-readable storage media, data processors, processing devices, control devices transmitters, receivers, antennas, transceivers, input devices, output devices, network interface devices, and other types of components that are apparent to those skilled in the art. It will be appreciated that modules may share resources. For example, two modules described separately herein may share a common processing unit and memory.

As shown in FIG. 2, the contact center management server 110 includes a communications server module 200, a scenario calculation module 202, and an agent analytics module 204. In operation, the communications server module 200 establishes and manages two-way communications between customer devices 102, the agent device 122, and optionally the supervisor device 118. In this regard, the agent device 122 includes a communications agent module 212 and the supervisor device 118 includes a communications supervisor module 222 that are operable to establish a two-way communication link with a customer device 102 in cooperation with the communications server module 200. The communications server module 200 may be further operable to manage inbound communications, including placing inbound communications in a queue and routing communications to the next open agent. The communications server module 200 may be further operable to gather preliminary customer information.

The agent device 122 may further include an agent interface module 210, input devices 214, a display 216, and output devices 218. The input devices 214 may include keyboard, touchscreens, computer mouse, and other standard input devices that allow a user to provide input to a computing device. The output devices 218 may include speakers and microphone, such as in an operator's headset that are employed in most contact centers. The display 216 is a computer display, such as a computer monitor, LED display, or flat screen display, that is operable to display computer-generated content to a user.

The agent interface module 210 provides a computer-generated and virtual dashboard on the display 216 to an agent. The virtual dashboard may display information regarding customers' accounts as will be described in more detail hereinafter. Through the virtual dashboard, an agent is able to interact with the contact center 104 during a session with a customer. The virtual dashboard is populated with information from the business database 114 and the customer database 116. The dashboard may be populated automatically or in response to a query by an agent. The agent may modify, change, update, delete information stored in the customer database 116 through the virtual dashboard. In addition, the agent may modify the customer's account through the virtual dashboard. For example, an agent may be able to modify a customer's contract through the virtual dashboard. Such modifications, changes, updates, deletions, etc. may be representative of terms in a scenario, such as payment terms, in terms of financial payments or timing of payments, quality of service issues, customer attitude issues, equipment issues, and so forth.

The supervisor device 118 may further include a supervisor interface module 220, input devices 224, a display 226, and output devices 228. The input devices 224 may include keyboard, touchscreens, computer mouse, and other standard input devices that allow a user to provide input to a computing device. The output devices 228 may include speakers and microphone, such as in an operator's headset. The display 226 is a computer display, such as a computer monitor, LED display, or flat screen display, that is operable to display computer-generated content to a user.

The supervisor interface module 220 provides a computer-generated and virtual dashboard on the display 226 to a supervisor. The virtual dashboard may display real-time information regarding customers' accounts and may mirror the information in the virtual dashboard generated by the agent interface module 210 and shown on the display 216 of the agent device 122.

Turning back to the contact center management server 110, the scenario calculation module 202 is operable to calculate and determine improved scenarios for customers based, at least partially, on the information in the customer database 116 and the business database 114. The improved scenarios may be further calculated and determined based upon input received through the virtual dashboard generated by the agent interface module 210. That is, the scenario calculation module 202 may employ algorithms to determine improved scenarios for a customer. The algorithms should ensure that the customer remains profitable to the organization with any changes to the customer's account made by an agent.

It will be appreciated that the scenario calculation module 202 generates these results in the background. By using different algorithms, it will calculate the best possible scenario for the customer and the organization. For example: If a customer wants to lower his monthly bill and he has seven months left on his contract, the agent will type in the requested monthly bill and scenario calculation module 202 will prompt the agent to renew the customer's contract using an auto-generated scenario that is good for the customer and is profitable to the company.

In another example, if a customer calls in because his equipment is faulty, and he as six months left on his contract and he is looking for other companies with better equipment, the scenario calculation module 202 will generate improved scenarios. A first generated scenario may include an offer to replace the old piece of equipment at no charge, then quickly go into offering him new equipment that will work better and generate more money for the organization. In another scenario, the customer may be presented with a scenario to replace all of his equipment with new equipment with no upfront cost if he was to renew for a set period of months/years. The scenario calculation module 202 may receive agent input to calculate the renewal term. The scenario calculation module 202 may offer different scenarios that are solutions to the customer's issue. It will be appreciated that going through these steps is meant to optimize and speed up the process of helping a customer while meeting the customer's expectations and satisfaction requirements.

The scenario calculation module 202 may be further operable to generate an internal profitability rating for customers. The profitability rating may be based on the account history of the customer with the organization. The profitability rating may also be determined for the improved scenarios calculated for a customer. The improved scenarios may be used to populate the virtual dashboard generated by the agent interface module 210. Customer profitability ratings may also be used to populate the virtual dashboard generated by the agent interface module 210. The scenario calculation module 202 may also calculate the profitability of a customer over the life of a contract and the proposed changes to the customer's contract.

The customer profitability ratings may be used to limit or prohibit changes to a customer's account by an agent. For example, if an agent attempts to enter a change to the customer's account through a virtual dashboard generated by the agent interface module 210 of the agent device 122 that is unprofitable to the organization, the agent interface module 210 will prohibit the change. In addition, the agent may be presented with alternative and improved scenarios that are profitable to the organization.

The agent analytics module 204 of the contact center management server 110 is operable to determine the profitability of agents. In particular, the agent analytics module 204 generates information regarding an agent's performance while servicing customers. For example, the agent analytics module 204 generates information regarding the profitability of the edits, changes, and/or modifications made by agents to customers' accounts. The information generated by the agent analytics module 204 may be displayed on the display 226 of the supervisor device 118. It will be appreciated that this allows the supervisor to monitor the performance of agents using the supervisor device 118.

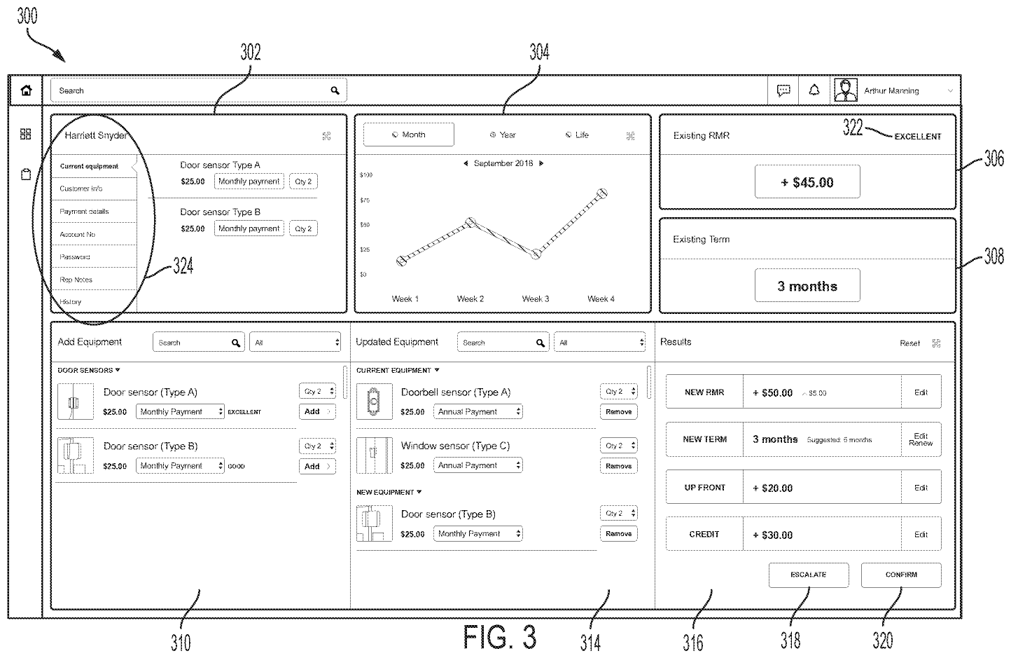

Referring now to FIG. 3, there is depicted an exemplary virtual dashboard 300 that may be generated on a display 216 of an agent device 122 by the agent interface module 210. The virtual dashboard 300 may display information on customers' accounts and may also allow agents to adjust and make changes to the customers' accounts. Through the virtual dashboard 300, an agent may conduct a customer search using phone number, name, address, account number, and other customer information. The virtual dashboard 300 may automatically populate with customer information if a customer device 102 is attached to a customer account.

The virtual dashboard 300 may provide a customer rating 322 based upon information about the customer obtained from the customer database 116. In an embodiment, the customer rating 322 is based upon one or more of: the total profit made throughout a customer's contract, payment history, call history (prior issues), package (if applicable), contract details, and remaining months on a contract. The customer rating 322 may be displayed on the virtual dashboard 300 in a wide-variety of manners, including, a star rating, a word rating, e.g., Excellent, Good, Average, Poor, and Bad. The customer rating may also be displayed pursuant to a color scheme, green=good and red=bad. It will be appreciated that the customer rating may be displayed in a wide variety of manners.

Depending on the customer's rating, the auto-generated recommendations to a customer's issue may vary. For example, for customers with a high profitability rating, recommended changes to the customer's account may be one scenario while customers with a low profitability rating may be given another scenario. Further, the auto-generated recommendations may be influenced by the customer issue, i.e., the reason for the call to the contact center.

The virtual dashboard 300 will give different options to help an agent determine the best scenarios for a customer. The virtual dashboard 300 may provide a pick list of common issues that allows the agent to identify the customer's issue. Example questions/statements could be:

My equipment seems outdated.

What are the specials on new equipment?

How can I lower my monthly bill?

Does my contract automatically renew?

I want to cancel

I am not happy with my equipment.

I am not happy with the service.

These are all questions that can lead to the virtual dashboard 300 providing improved scenarios to the agent for recommendation to the customer.

The dashboard 300 includes a plurality of windows that display pertinent information. In this example, the dashboard 300 includes windows 302, 304, 306, 308, 310, 314, and 316. The windows 302-316 may be populated from information from the customer database 116 and the business database 114. The windows 302-316 may also be populated by information generated by the scenario calculation module 202 and the agent analytics module 204.

The windows 302-316 may be populated automatically when a customer device 102 is connected to the agent device 122. Alternatively, an agent may perform a database search to locate a customer's information. In addition, the information in the windows 302-316 may be updated during a session with a customer as well.

Window 302 may include a menu 324 that allows an agent to select the information displayed in that window. The menu 324 may include selections for Current Equipment, Customer Info, Payment Details, Account Number, Password, Rep Notes, and History. As shown in FIG. 3, the selection of Current Equipment causes the current equipment owned or being used by the customer to be displayed in window 302.

Window 304 shows the profitability of the customer over a selectable time period. The information may be generated by the scenario calculation module 202. The information may be displayed in a graph for the selected time period. Window 306 shows the current profitability of the customer as well as the customer's internal profitability rating. Window 308 displays the existing term left on the customer's contract.

Window 310 displays a list of available products or services that may be added to the customer's account. Window 314 displays a list of products selected from window 310 by the agent. Window 316 shows the proposed updates to the customer's account and the updated profitability information of the customer based upon those updates.

The dashboard 300 further includes virtual buttons 318 and 320 that are selectable by an agent. The virtual button 318 allows an agent to immediately contact a supervisor at the supervisor device 118 if needed. This may occur when a customer cannot be satisfied by an agent. When an agent selects the virtual button 318, the virtual dashboard 300 may be mirrored on the supervisor device 118. The supervisor device 118 may also allow the supervisor to monitor the communications between the agent and the customer. The virtual button 320 may confirm the proposed changes to the customer's account and contract.

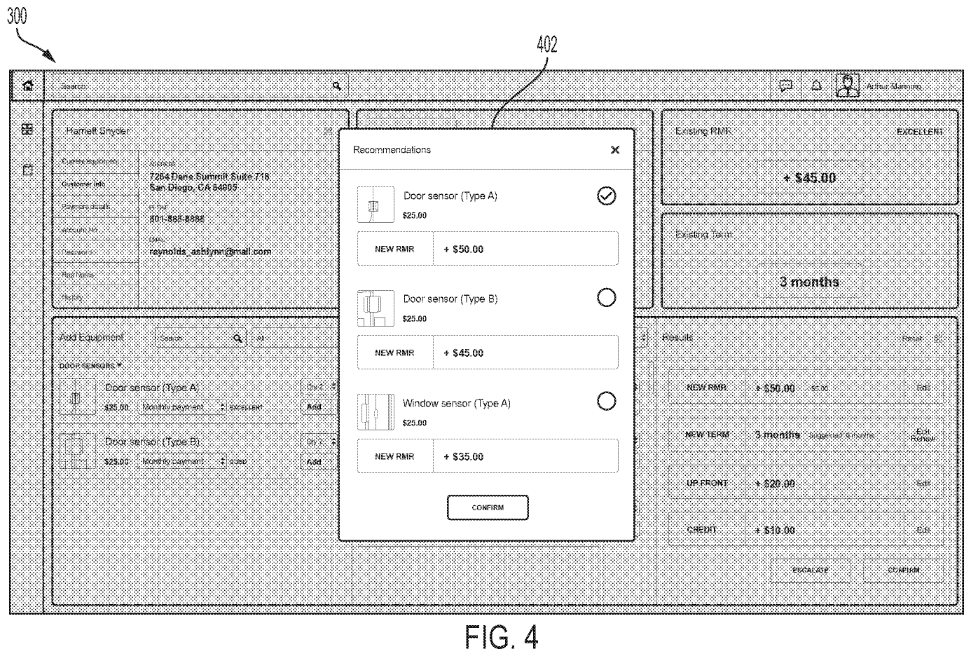

Referring to FIG. 4, the virtual dashboard 300 may also make product recommendations for the agent to present to a customer during a session. The product recommendations may be products (or services) that will increase the profitability of the customer to the organization. In FIG. 4, the product recommendations are displayed to a user in a popup window 402.

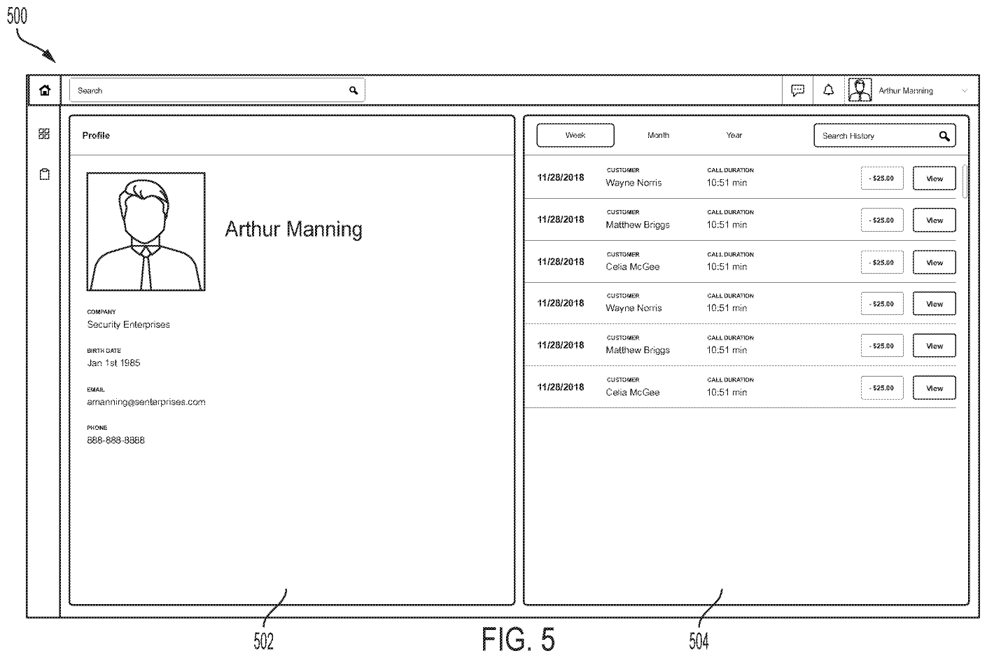

Referring to FIG. 5, there is shown a virtual dashboard 500 that may be generated on the display 226 of the supervisor device 118 by the supervisor interface module 220. The virtual dashboard 500 may include agent information as well as information generated by the agent analytics module 204. The dashboard 500 may include windows 502 and 504. Window 502 may include agent information.

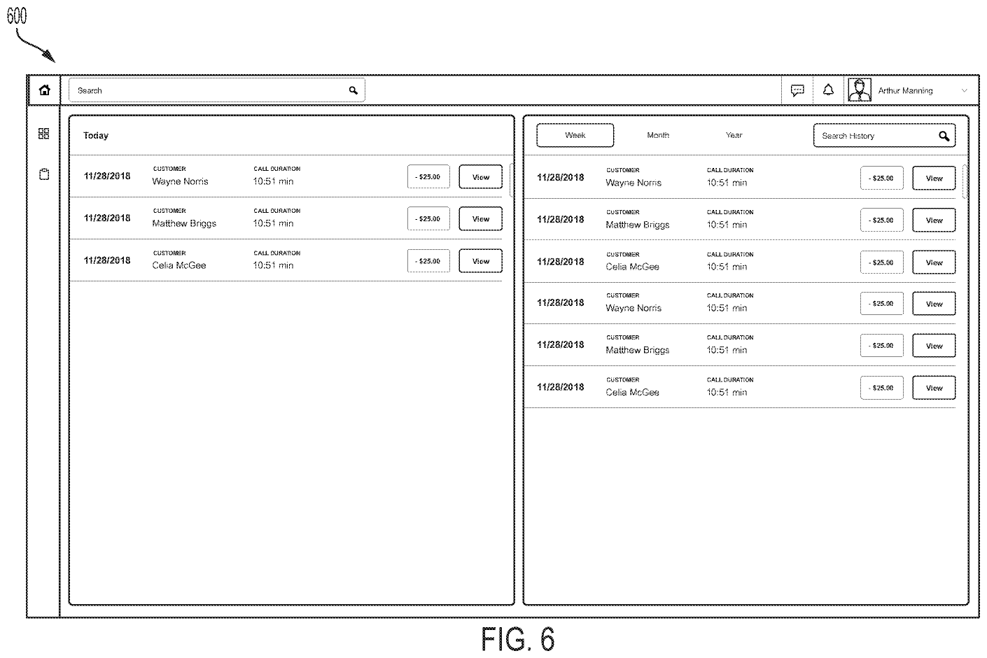

Window 504 may display information regarding the previous sessions of the agent with customers. The window 504 may include information relating to the date of the session, the name of the customer, the duration of the session and profitability information based upon the outcome of the session. Referring to FIG. 6, a virtual dashboard 600 may be generated on the display 226 of the supervisor device 118 that shows the profitability of each session with a customer by an agent for specific time period. It will be appreciated that using this information, that the effectiveness of an agent may be determined based upon the profitability of the agent to the organization.

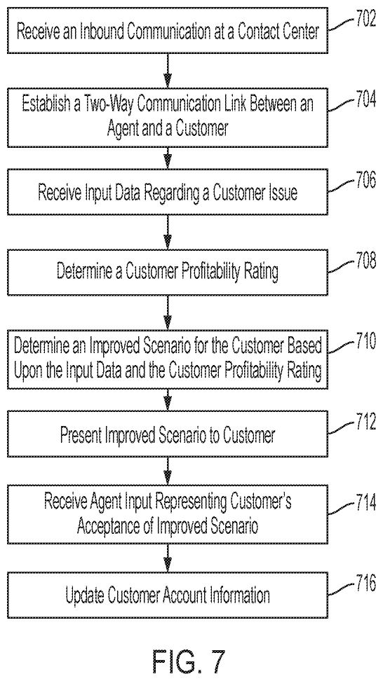

Referring to FIG. 7, a procedure of processing an inbound communication from a customer at a contact center is shown. At step 702, an inbound communication to a contact center is routed to an agent. At step 704, a two-way commination session is established between the agent and a customer. At step 706, the agent inputs information regarding the customer's issue, i.e., the customer's reason for contacting the contact center, using an agent device. At step 708, a scenario calculation module determines a customer's profitability rating based upon historical customer data. At step 710, the scenario calculation module generates improved scenarios for the customer based upon the agent's input at the agent device and the customer's profitability rating. At step 712, the agent presents the improved scenario to the customer. At step 714, the agent confirms the customer's acceptance of the improved scenario. At step 716, the customer's account information in a database is updated based upon the changes made by the improved scenario.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments. For example, components described herein may be removed and other components added without departing from the scope or spirit of the embodiments disclosed herein or the appended claims.

Other embodiments will be apparent to those skilled in the art from consideration of the specification and practice of the disclosure disclosed herein. It is intended that the specification and examples be considered as exemplary only, with a true scope and spirit of the invention being indicated by the following claims.

What is claimed is:

1. A system, comprising:
a processor;
a display device; and
a computer-readable storage medium containing instructions which when executed by the processor cause the processor to perform a method, the method comprising:
determining, by the processor, a rating for a customer;
displaying, on the display device, an indication of the rating for the customer;
determining, by the processor, that the rating meets a predetermined threshold;
adjusting, by the processor in response to input from a user, one or more terms of a relationship scenario based on the rating; and
storing, in the computer-readable storage medium by the processor, customer account information to reflect the adjusted one or more terms.

2. A system, comprising:
a processor;
a display device; and
a computer-readable storage medium containing instructions which when executed by the processor cause the processor to perform a method, the method comprising:
determining, by the processor, a rating for an agent;
displaying, on the display device, an indication of the rating for the agent;
quantifying a monetary value of updates made to customer account information;
storing, in the computer readable storage medium, by the processor, the monetary value of updates made to customer account information by the agent;
determining, by the processor, a monetary value of updates made to customer account information by the agent over time;
displaying, by the display device, the monetary value of the updates made to customer account information made by the agent over time.
